(19) United States
(12) Patent Application Publication
(10) Pub. No.: US 2026/0243386 A1
(43) Pub. Date: Aug. 20, 2026

(54) DUAL VIBRATION RESONANCE BRACKET

(71) Applicant: International Truck Intellectual Property Company, LLC, Lisle, IL (US)

(72) Inventors: Nasir Imtiaz, Plainfield, IL (US); Lezza Ann Mignery, Naperville, IL (US); Gary Steven Boone, Downers Grove, IL (US)

(73) Assignee: International Truck Intellectual Property Company, LLC, Lisle, IL (US)

(21) Appl. No.: 19/053,903

(22) Filed: Feb. 14, 2025

(51) Int. Cl. F16M 7/00; F01P 5/10; F02M 26/29; F16F 7/104

(52) U.S. Cl. CPC F16M 7/00; F01P 5/10; F02M 26/29; F16F 7/104; F16F 2222/08

(57) ABSTRACT

An apparatus for reducing or eliminating vibration of engine mounted accessories includes a coupling device. The coupling device is connected to the structure, body, or external housing of a first engine mounted accessory or its mounting device and to the structure, body, or external housing of a second engine mounted accessory or its mounting device. The mounting surfaces of the mounting devices of the engine accessories may be substantially perpendicular. The coupling device may be a rigid coupling device or a resonance frequency tuning device. One of the engine accessories may be an EGR cooler, and the other may be a coolant distribution pump and/or system.

### BACKGROUND

This disclosure relates to a Dual Vibration Resonance Bracket used to control resonance frequency and/or characteristics of engine components and thereby reduce vibration thereof. Particularly, this disclosure relates to a device and method that connects the mounting of two or more such engine components together in order to do so.

### RELATED ART

Modern day vehicle internal combustion engines are provided with many engine-mounted devices for the purpose of supporting engine and vehicle functions. For non-limiting example, such engine mounted devices may include alternators, generators, heat exchangers, turbochargers, superchargers, power steering pumps, filters, distributors, fuel pumps, coolant pumps, air compressors, air conditioning compressors, coolant distribution systems, and etcetera. Each of these devices is variously mounted to the main structure of the engine and is driven or in fluid connection therewith.

Modern day vehicle internal combustion engines are also characterized by vibrations that occur in multiple modes and derive from various sources. A primary source of engine vibration is torsional vibration about the longitudinal axis of the engine due to compression and combustion strokes of the pistons and connecting rods, and the resultant variation in rotational speed of the crankshaft and driveline. Torsional vibration may be exacerbated by an engine that is in a poor state of maintenance, resulting in uneven cylinder firing. Other sources of engine vibration may include driveline feedback, crankshaft whip and/or twist, road vibrations, chassis component vibrations, and even the engine mounted devices themselves.

As a result of engine vibrations, harmful harmonic forces are introduced into the engine mounted devices by way of their mountings, creating a higher risk of failure and lowering the durability of the engine mounted devices. For non-limiting example, an Exhaust Gas Recirculation (EGR) cooler, which is a device for transferring heat from exhaust gas being recirculated into the engine intake to engine coolant, is often mounted longitudinally so that its major axis is more or less parallel with the longitudinal axis of the engine. In this configuration, it is mounted offset from the block of the engine. As a result, it is susceptible to torsional vibrations about its mounting resulting from engine generated vibration, which vibrations may be destructive to the EGR cooler. Moreover, an excessive amount of motion may be observed due to specific resonance frequency of the EGR system. Similar excessive amounts of motion may be observed in other engine mounted devices due to specific resonance frequencies, such as specific resonance of the engine coolant distribution housing.

In order to compensate for such vibrations, with regards to the EGR cooler or otherwise, such engine mounted devices are generally mounted very rigidly to the engine structure. This results in mounting structures and the engine mounted devices themselves being very heavy, complex, and expensive to manufacture, which is contrary to the overall efficiency and weight reduction goals for the engine and vehicle. Moreover, increasing local component level isolation systems can increase the complexity of the overall system and thereby pose a higher durability risk of failure. What is needed in the art, therefore, is an improved way to control vibration in engine mounted devices while minimizing the weight, complexity, and expense of the mounting structures that are used.

### SUMMARY

According to one embodiment, an apparatus for reducing or eliminating vibration of engine mounted accessories includes a coupling device that extends between and is connected to the structure, body, or external housing of a first engine mounted accessory and/or the mounting device of the first engine mounted accessory, and the structure, body, or external housing of a second engine mounted accessory and/or the mounting device of the second engine mounted accessory.

According to another embodiment, a vehicle includes an apparatus for reducing or eliminating vibration of engine mounted accessories that includes a coupling device that extends between and is connected to the structure, body, or external housing of a first engine mounted accessory and/or the mounting device of the first engine mounted accessory, and the structure, body, or external housing of a second engine mounted accessory and/or the mounting device of the second engine mounted accessory.

According to yet another embodiment, a method for reducing or eliminating vibration of engine mounted accessories, includes several steps. The main step is connecting a coupling device to the structure, body, or external housing of a first engine mounted accessory and/or the mounting device of the first engine mounted accessory, and to the structure, body, or external housing of a second engine mounted accessory and/or the mounting device of the second engine mounted accessory

### DESCRIPTION OF THE DRAWINGS

FIGS. 1 and 2 are front perspective views of an engine having engine mounted accessories;

FIG. 3 is a front perspective view of an engine with engine mounted accessories experiencing harmful vibrational forces;

FIG. 4 is a front perspective view of an engine having an embodiment of a Dual Vibration Resonance Bracket;

FIG. 5 is a front view of an engine having an embodiment of a Dual Vibration Resonance Bracket;

FIGS. 6 through 10 are partial front perspective views of embodiments of a Dual Vibration Resonance Bracket connected to an EGR cooler and to a coolant distribution pump and/or system; and

FIG. 11 is a front perspective view of an engine having an alternate embodiment of the Dual Vibration Resonance Bracket.

### DETAILED DESCRIPTION

Embodiments described herein relate to an apparatus and method for reducing or eliminating undesirable vibration of engine mounted accessories. The apparatus and method may be applied to various types of engine systems, including engine systems of generators, unmanned vehicles, submarines, or vehicles, including passenger vehicles, commercial vehicles, and recreational vehicles, such as highway or semi-tractors, straight trucks, busses, fire trucks, motorhomes, and etcetera. It is contemplated that the apparatus and method may be applied to vehicles having drivetrains including a diesel, gasoline, or gaseous fuel engine, as well as to vehicles having hybrid electric drivetrains. It is further contemplated that the apparatus and method may be applied to vehicles having manual transmissions, automatic transmissions, automated manual transmissions, continuously variable transmissions, hybrid electric transmissions, and hydraulic transmissions, as non-limiting examples. It is further contemplated that the apparatus and method may be applied to autonomous or semi-autonomous vehicles.

The Dual Vibration Resonance Bracket may function by modularly coupling together the mounting devices of two or more engine mounted accessories. Alternatively, the Dual Vibration Resonance Bracket may function by coupling together the structure, body, or external housing of one engine mounted accessory itself with the mounting device of another engine mounted accessory. Still alternatively, the Dual Vibration Resonance Bracket may function by coupling together the structure, body, or external housing of one engine mounted accessory itself with the structure, body, or external housing of another engine mounted accessory itself. As a result of coupling together the mounting devices of two or more engine mounted accessories and/or the structures, bodies, or external housings of the two or more engine mounted accessories themselves, the resonance frequencies of either or both of the engine mounted accessories and/or their mounting devices are controllably changed to reduce or eliminate undesirable vibration and motion of the engine mounted accessories. In this way, harmful forces experienced by the engine mounted accessories are reduced while minimizing the weight, complexity, and expense of the mounting structures that are used and improving the performance and reliability of the engine mounted accessories.

In some embodiments, the Dual Vibration Resonance Bracket may connect together the mounting devices of two or more engine mounted accessories and/or the structures, bodies, or external housings of the two or more engine mounted accessories themselves in an arrangement wherein the mounting surfaces of the mounting devices are substantially perpendicular to one another. For the purposes of the present disclosure, substantially perpendicular means that the planes of the mounting surfaces are non-parallel by at least about 45 degrees, more preferably at least about 60 degrees, still more preferably at least about 75 degrees, still more preferably about 90 degrees. By connecting together the mounting devices of two or more engine mounted accessories and/or the structures, bodies, or external housings of the two or more engine mounted accessories themselves in an arrangement wherein the mounting surfaces of the mounting devices are substantially perpendicular to one another, instead of vibrational forces acting to bend the mounting device of one of the engine mounted accessories, the Dual Vibration Resonance Bracket instead transmits the forces in shear to the mounting surface of the mounting device of the other engine mounted accessory. Such forces are more effectively transmitted by the Dual Vibration Resonance Bracket acting in shear, than when such forces are transmitted by the mounting device of the first engine mounted accessory acting in bending. This is particularly true for resonant cyclical forces, which focus the stress upon the mounting bolts of the mounting device of the first engine mounted accessory, which may then suffer fatigue stress failures due to stress concentration at the interface.

The Dual Vibration Resonance Bracket may function by rigidly coupling together the mounting devices of two or more engine mounted accessories and/or the structures, bodies, or external housings of the two or more engine mounted accessories themselves. Alternatively, the Dual Vibration Resonance Bracket may function by coupling together the mounting devices of two or more engine mounted accessories and/or the structures, bodies, or external housings of the two or more engine mounted accessories themselves by way of a resonance frequency tuning device which may include one or more springs, dampers, and/or masses, or combinations thereof. In this way, the resonance frequencies of either or both of the engine mounted accessories and/or their mounting devices may be further controllably changed or shifted as a result of coupled motion to reduce or eliminate undesirable vibration of the engine mounted accessories.

This is accomplished by controlling the natural frequency, spring rate, mass, and/or damper characteristics of the resonance frequency tuning device. In some embodiments, the resonance frequency tuning device may further comprise a tuned mass damper. In such embodiments, one of the elements of the resonance frequency tuning device is a mass and spring combination that has an oscillation frequency tuned to be similar to the resonant frequency of the engine that is most harmful to one or both of the engine mounted accessories. In so doing, the mass of the resonance frequency tuning device absorbs most of the motion and energy being transmitted from the engine, thereby sparing the mounting devices of two or more engine mounted accessories and/or the structures of the two or more engine mounted accessories themselves from the harmful engine driven vibrations.

Certain engine mounted accessories, such as an Exhaust Gas Recirculation (EGR) cooler, are more susceptible to damage from engine vibrations due to the nature of their construction. EGR coolers, and other heat exchangers, comprise passageways for fluids that adjoin one another. In order to facilitate heat transfer, the passageways are separated by comparatively thin materials and are often minimally supported by internal structures. Moreover, they often transfer heat between working fluids that vary widely in density, compressibility, and other characteristics. For example, in a gas to liquid heat exchanger such as an EGR cooler, the liquid may pass through multiple thin tubes while the gas circulates around them. Uncontrolled engine vibrations may then cause these thin tubes within to resonate, fatigue, and fail. Moreover, as discussed supra, the body of the EGR cooler may be suspended offset from the longitudinal axis of the engine, so that the body of the EGR cooler itself may be susceptible to resonance with engine vibration frequencies. These vibrations may then be destructive to the body of the EGR cooler and its mounting, as well as to the internal structures contained therein.

In one embodiment, therefore, the mounting device of the EGR cooler and/or the structure, body, or external housing of the EGR cooler itself may be coupled with the mounting device of the coolant distribution pump and/or system and/or the structure, body, or external housing of the coolant distribution pump and/or system itself. In this embodiment, the mounting device of the EGR cooler is in fact perpendicular to the mounting device of the coolant distribution pump and/or system. As a result, the Dual Vibration Resonance Bracket transmits the vibration forces from the EGR cooler in shear to the mounting surface of the mounting device of the coolant distribution pump and/or system, thereby reducing harmful vibrations experienced by the EGR cooler and its mounting device. In this embodiment, the mounting device of the EGR cooler and/or the structure, body, or external housing of the EGR cooler itself may be rigidly coupled with the mounting device of the coolant distribution pump and/or system and/or the structure, body, or external housing of the coolant distribution pump and/or system itself or may be coupled by way of a resonance frequency tuning device. In this way, the resonance frequency of the EGR cooler may be controllably changed or shifted to reduce or eliminate undesirable vibration of the EGR cooler.

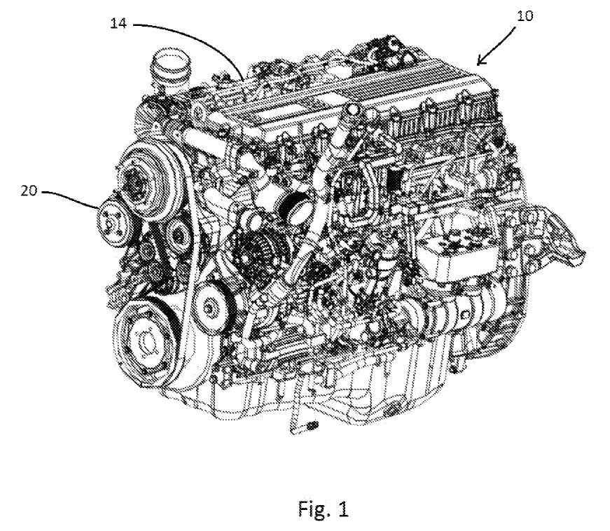

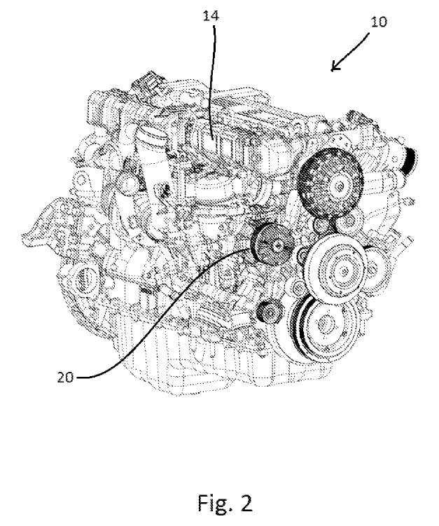

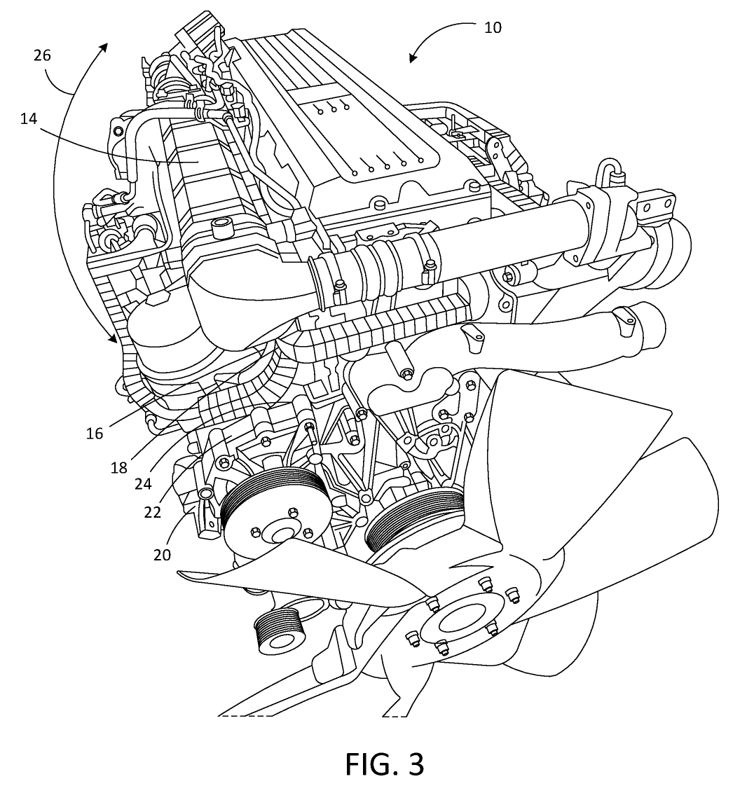

Turning now to FIGS. 1 and 2, an engine 10 having an EGR cooler 14 and a coolant distribution pump and/or system 20 is shown. FIG. 3 shows the same engine 10 having the EGR cooler 14 and the coolant distribution pump and/or system 20. The EGR cooler 14 may be attached to the engine 10 by way of an EGR cooler mounting device 16, which may be mounted to the EGR cooler mounting surface 18. The EGR cooler mounting surface 18 is generally planar and is located along the right side of the engine 10 parallel to the longitudinal axis of the engine 10. The coolant distribution pump and/or system 20 is attached to the engine 10 by way of a coolant distribution pump and/or system mounting device 22, which is mounted to the coolant distribution pump and/or system mounting surface 24. The coolant distribution pump and/or system mounting surface 24 is generally planar and is located at the front of the engine 10 perpendicular to the longitudinal axis of the engine 10. Because the EGR cooler 14 is oriented generally parallel with the engine 10 and offset from the crankshaft (not shown) of the engine 10, it is subject to resonant cyclical forces 26.

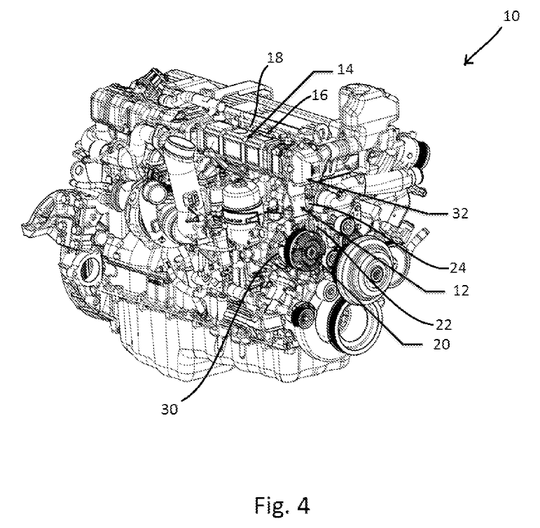

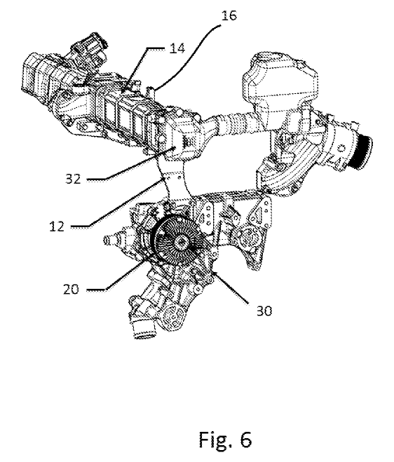

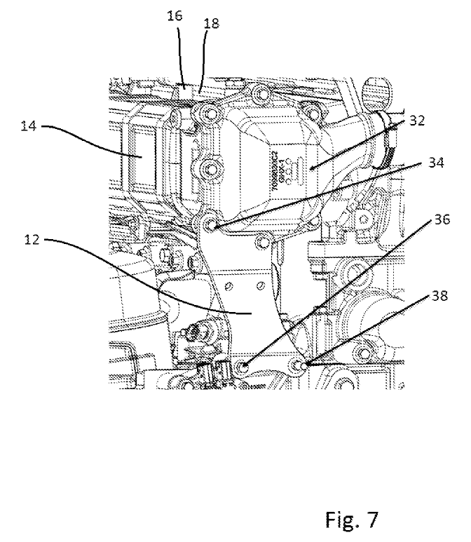

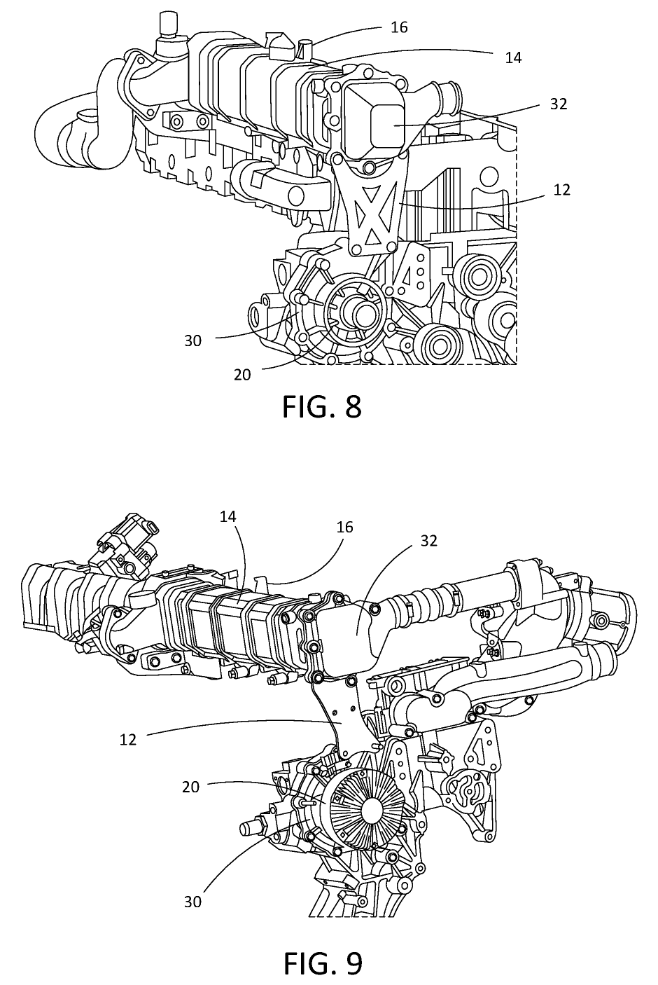

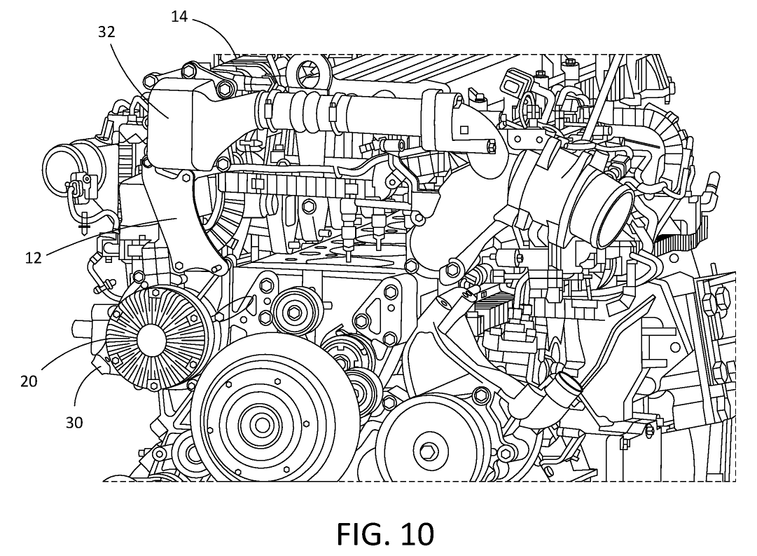

FIGS. 4 through 10 show embodiments of the Dual Vibration Resonance Bracket 12 installed on an engine 10 having an EGR cooler 14 and a coolant distribution pump and/or system 20. The EGR cooler 14 is again attached to the engine 10 possibly by way of an EGR cooler mounting device 16, which is again mounted to the EGR cooler mounting surface 18. The EGR cooler mounting surface 18 is again generally planar and is again located along the right side of the engine 10 parallel to the longitudinal axis of the engine 10. The coolant distribution pump and/or system 20 may again be attached to the engine 10 by way of a coolant distribution pump and/or system mounting device 22, which is again mounted to the coolant distribution pump and/or system mounting surface 24. The coolant distribution pump and/or system mounting surface 24 is again generally planar and is located at the front of the engine 10 perpendicular to the longitudinal axis of the engine 10. The Dual Vibration Resonance Bracket 12 may connect the body of the EGR cooler 14 to the coolant distribution pump and/or system mounting device 22, so that motion and stresses arising from resonant cyclical forces 26 (not shown in FIGS. 4 through 10) are better absorbed and cancelled out by the Dual Vibration Resonance Bracket 12 acting in shear upon the coolant distribution pump and/or system mounting surface 24 through the coolant distribution pump and/or system mounting device 22.

Although the Dual Vibration Resonance Bracket 12 may connect the body of the EGR cooler 14 to the coolant distribution pump and/or system mounting device 22, it is contemplated that the Dual Vibration Resonance Bracket 12 may alternately connect the body of the EGR cooler 14 directly to the body of the coolant distribution pump and/or system 20, for example to the coolant distribution housing assembly 30, or that the Dual Vibration Resonance Bracket 12 may connect the EGR cooler mounting device 16 to either the coolant distribution pump and/or system mounting device 22 or to the body of the coolant distribution pump and/or system 20. In one embodiment, the Dual Vibration Resonance Bracket 12 connects to the body of the EGR cooler 14 adjacent to an EGR cooler reed valve housing 32 that is connected to the end of the EGR cooler 14 by way of EGR mounting upper coupler bolts 34. In this embodiment, the Dual Vibration Resonance Bracket 12 also connects to the coolant distribution housing assembly 30 and/or coolant distribution pump and/or system mounting device 22 by way of water pump lower coupler bolts 36 and/or the water pump lower coupler stud bolt 38. In any of these embodiments, the motion and stresses arising from resonant cyclical forces 26 are better absorbed and cancelled out by the Dual Vibration Resonance Bracket 12 acting in shear upon the coolant distribution pump and/or system mounting surface 24, through the coolant distribution pump and/or system mounting device 22 and/or the coolant distribution housing assembly 30 of the coolant distribution pump and/or system 20.

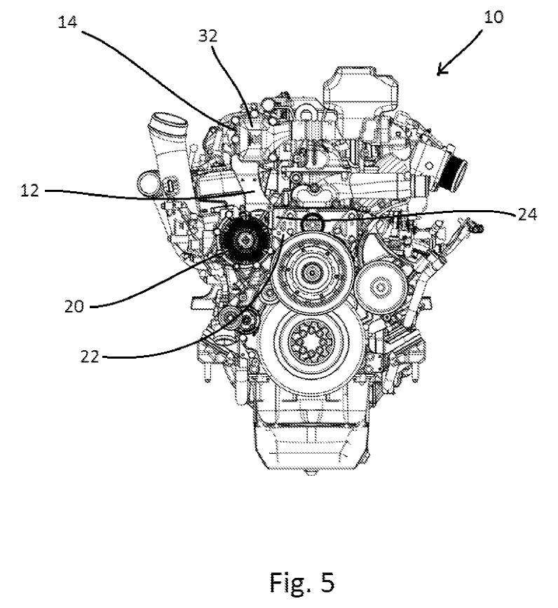

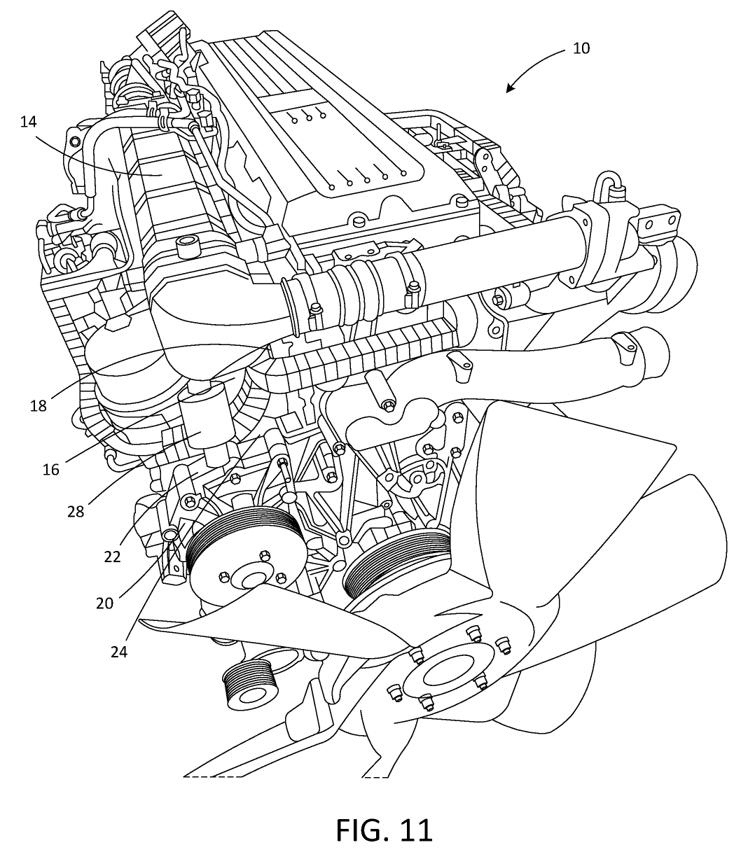

FIG. 11 shows another embodiment of the invention installed on an engine 10 having an EGR cooler 14 and a coolant distribution pump and/or system 20. The EGR cooler 14 is again attached to the engine 10 by way of an EGR cooler mounting device 16, which is again mounted to the EGR cooler mounting surface 18. The EGR cooler mounting surface 18 is again generally planar and is again located along the right side of the engine 10 parallel to the longitudinal axis of the engine 10. The coolant distribution pump and/or system 20 is again attached to the engine 10 by way of a coolant distribution pump and/or system mounting device 22, which is again mounted to the coolant distribution pump and/or system mounting surface 24. The coolant distribution pump and/or system mounting surface 24 is again generally planar and is located at the front of the engine 10 perpendicular to the longitudinal axis of the engine 10. In the embodiment shown in FIG. 5, a resonance frequency tuning device 28 connects the body of the EGR cooler 14 to the coolant distribution pump and/or system mounting device 22, so that motion and stresses arising from resonant cyclical forces 26 (not shown in FIG. 5) are attenuated by the resonance frequency tuning device 28.

While illustrative arrangements, and control logic therefor, implementing the engine system have been described with respect to at least one embodiment, the arrangements and methods can be further modified within the spirit and scope of this disclosure, as demonstrated previously. This application is therefore intended to cover any variations, uses, or adaptations of the arrangement and method using its general principles. Further, this application is intended to cover such departures from the present disclosure as come within known or customary practice in the art to which the disclosure pertains and which fall within the limits of the appended claims.

What is claimed is:

1. An apparatus for reducing or eliminating vibration of engine mounted accessories, comprising:
a coupling device extending between and connected to:
at least one of a structure, body, or external housing of a first engine mounted accessory and a mounting device of the first engine mounted accessory, and
at least one of a structure, body, or external housing of a second engine mounted accessory and a mounting device of the second engine mounted accessory.

2. The apparatus of claim 1, wherein:
a mounting surface of the mounting device of the first engine mounting accessory being substantially perpendicular to a mounting surface of the mounting device of the second engine mounting accessory.

3. The apparatus of claim 2, wherein:
the coupling device further comprises a rigid coupling device.

4. The apparatus of claim 2, wherein:
the coupling device further comprises a resonance frequency tuning device.

5. The apparatus of claim 4, wherein:
the resonance frequency tuning device further comprises at least one of a spring, a damper, and a mass.

6. The apparatus of claim 1, wherein:
one of the first engine mounted accessory and the second engine mounted accessory is an EGR cooler.

7. The apparatus of claim 6, wherein:
the coupling device is connected the EGR cooler adjacent to a EGR cooler valve housing.

8. The apparatus of claim 7, wherein:
another of the first engine mounted accessory and the second engine mounted accessory is a coolant distribution pump and/or system.

9. A vehicle having an apparatus for reducing or eliminating vibration of engine mounted accessories, the apparatus comprising:
a coupling device extending between and connected to:
at least one of a structure, body, or external housing of a first engine mounted accessory and a mounting device of the first engine mounted accessory, and
at least one of a structure, body, or external housing of a second engine mounted accessory and a mounting device of the second engine mounted accessory.

10. The vehicle of claim 9, wherein:
a mounting surface of the mounting device of the first engine mounting accessory being substantially perpendicular to a mounting surface of the mounting device of the second engine mounting accessory.

11. The vehicle of claim 10, wherein:
the coupling device further comprises a rigid coupling device.

12. The vehicle of claim 10, wherein:
the coupling device further comprises a resonance frequency tuning device.

13. The vehicle of claim 12, wherein:
the resonance frequency tuning device further comprises at least one of a spring, a damper, and a mass.

14. The vehicle of claim 9, wherein:
one of the first engine mounted accessory and the second engine mounted accessory is an EGR cooler.

15. The vehicle of claim 14, wherein:
the coupling device is connected the EGR cooler adjacent to a EGR cooler valve housing.

16. The vehicle of claim 15, wherein:
another of the first engine mounted accessory and the second engine mounted accessory is a coolant distribution pump and/or system.

17. A method for reducing or eliminating vibration of engine mounted accessories, comprising the steps of:
connecting a coupling device to:
at least one of a structure, body, or external housing of a first engine mounted accessory and a mounting device of the first engine mounted accessory, and to
at least one of a structure, body, or external housing of a second engine mounted accessory and a mounting device of the second engine mounted accessory.

18. The method of claim 17, wherein:
a mounting surface of the mounting device of the first engine mounting accessory being substantially perpendicular to a mounting surface of the mounting device of the second engine mounting accessory.

19. The method of claim 18, wherein:
the coupling device further comprises one of a rigid coupling device and a resonance frequency tuning device.

20. The method of claim 19, wherein:
the first engine mounted accessory is an EGR cooler and the second engine mounted accessory is a coolant distribution pump and/or system.
